(19) United States
(12) Patent Application Publication
(10) Pub. No.: US 2006/0145832 A1
(43) Pub. Date: Jul. 6, 2006

(54) Communication system and method

(76) Inventors: Yossi Bedarshi, Rishon Lezion (IL); Ofer Melman, Rishon Lezion (IL)

Correspondence Address: YOSSI BEDARSHI, 13 HAKEBARNIT STREET, RISHON LEZION, 75439, IL

(21) Appl. No.: 11/311,319

(22) Filed: Dec. 20, 2005

(30) Foreign Application Priority Data
Dec. 21, 2004 (GB) GB0427928.7

(51) Int. Cl. G08B 1/08; H04B 3/54; G08B 29/00; G08B 17/00

(52) U.S. Cl. 340/538.11; 340/506; 340/584; 307/1

(57) ABSTRACT

A second communication system using existing wires of a first alert system for other, additional communications purposes, comprising means for connecting to the wires in two or more locations, and means for connecting to external communication devices in each location. The alert system may include a fire alarm system. The system may also include a communication system controller for supporting the second communications system.

### CROSS-REFERENCE TO RELATED APPLICATIONS

The present application claims priority from the patent application No. GB0427928.7 filed in Great Britain by the present inventors on Dec. 21, 2004 and entitled “A communications system and method”.

### FIELD OF THE INVENTION

This invention relates to communication systems by wires, and more particularly to implementing a broadband network over an existing (network) infrastructure of a fire alarm system, or a new infrastructure of a fire alarm system

### BACKGROUND OF THE INVENTION

Many organizations, companies and hotels use fire alarm systems within their buildings.

Throughout the present disclosure, whenever fire alarm systems are mentioned, it is to be understood that the same also applies to smoke alarms, heat detectors, gas detectors and/or any kind of alarm system with detectors in several rooms or locations. Whenever fire detectors are mentioned, it is to be understood that the same also applies to smoke detectors, heat detectors, gas detectors and/or any kind of detectors.

Detectors may be connected along a serial line, where one or more such lines are connected to the control system. Such a connection will be herein referred to as “star connection”. Detectors may also be connected along a line, which is connected to the control system from both of its sides. Such a connection will be referred as “loop connection”.

Fire alarm systems are widely used, however their wires are usually used solely for the purpose of monitoring the detectors by a central control panel as required and setting an alarm under predefined conditions.

The control panel or control system is connected to the detectors, such as by one or more common wires, or in another manner.

The type of cables that are being used in the fire alarm system between the control system and the smoke detectors may be capable of supporting broadband communications.

The existing infrastructure could be used for other purposes as well, however special attention should be paid in order to preserve the original task of the system and its performance as a fire alert system.

### SUMMARY OF THE INVENTION

The invention provides a system and method for implementing a broadband network over an existing (network/cabling) infrastructure of a fire alarm system. The invention enables the usage of the existing installed base of fire alarm infrastructures for high-speed data transfer. The infrastructure can be used for applications such as the backbone of a wireless network to provide Internet services, as well as for Homeland Security video applications.

The type of cables that are being used in the fire alarm system between the control system and the smoke detectors usually can transfer high-speed data, such as up to 500 Mbps.

Independent network equipment and hardware modulating and filtering techniques can be used with those cables, in accordance to this invention, without interfering with the data transfer of the smoke detectors and even to improve the reliability of existing systems.

The novel system can allow adding many features to many users at a relatively low cost, by using the existing wire resources. This could be especially useful in hotels, retail outlets, universities, campuses, factories for example, where guests could access easily communication based services. Security services can be improved as well, allowing to place security devices at distant locations and communicating with these devices easily.

### BRIEF DESCRIPTION OF THE DRAWINGS

FIG. 1 illustrates a new system with a star connection and filters.

FIG. 2 illustrates the new system combined with a fire control system.

FIG. 3 illustrates the new system with a loop connection.

### DETAILED DESCRIPTION OF THE PREFERRED EMBODIMENTS

A preferred embodiment of the present invention will now be described by way of example and with reference to the accompanying drawings.

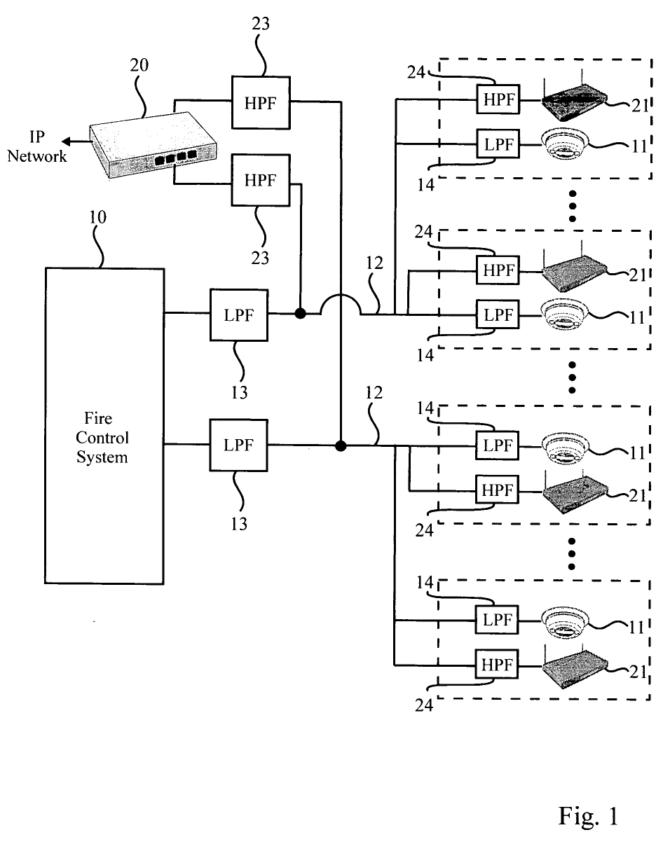

FIG. 1 illustrates the operation of the new system with star connection and filters. In one embodiment, the fire alert system comprising a fire control system 10, wiring infrastructure 12, I/O devices and detectors 11 may be isolated from the new communication system 20 and its devices 21, by using filters. Using this approach, minimal interference with existing fire alert system can be achieved.

This may be implemented by using, for example, Low Pass Filters (LPF) 13, in order to block the communication signals which are at higher frequencies than those of the fire alert system, and High Pass Filters (HPF) 23 in order to block fire alerting signals which are at lower frequencies.

Thus, the two systems can coexist in the same wire infrastructure with a minimal interference to each other. For example, even if a short circuit is caused by a device 21, the circuits may be so designed that it still is isolated by its HPF from the fire alert system.

The filters can be connected in parallel or serially to the wiring system, according to the nature of the connection of the detectors, in order to electronically separate between the two systems as was described. The filters, however, are optional, thus various configurations of filters may be used as required.

In order to separate between the fire alert system and the communication system, various means may be used, including but not limited to any combination of the following means:

1. Modulation of communication signals at frequencies where the fire alert system is inactive and/or not affected thereby.

2. Electronically separating between the two systems by using filters, as detailed in the present disclosure.

3. Blocking the line voltage of the sensors and supplying the required voltage to dedicated standard elements, these elements may replace existing sensors.

In case the wiring system is connected in a star connection type, where there are several branches and each branch wiring 12 is connected to the fire control system, the new communication system 20 may be connected to each branch separately, thus allowing users of each branch to share the whole possible bandwidth, without interfering with users of other branches.

The new communication system 20 may be implemented using any combination of the following: broadband switches, network elements 21 and/or adapters used to connect the network elements to the wiring system.

The wiring system could include additional elements, to better maintain and use the bandwidth. In a preferred embodiment, preferences for each junction along the wires could be defined in order to better support its communication bandwidth demands. This may be implemented using additional means and/or by definitions at the communication system controller. Access point elements may be installed close to the smoke detectors, which will allow easier installation and access.

Optionally, wireless access will be possible by using wireless supporting hardware at the network elements.

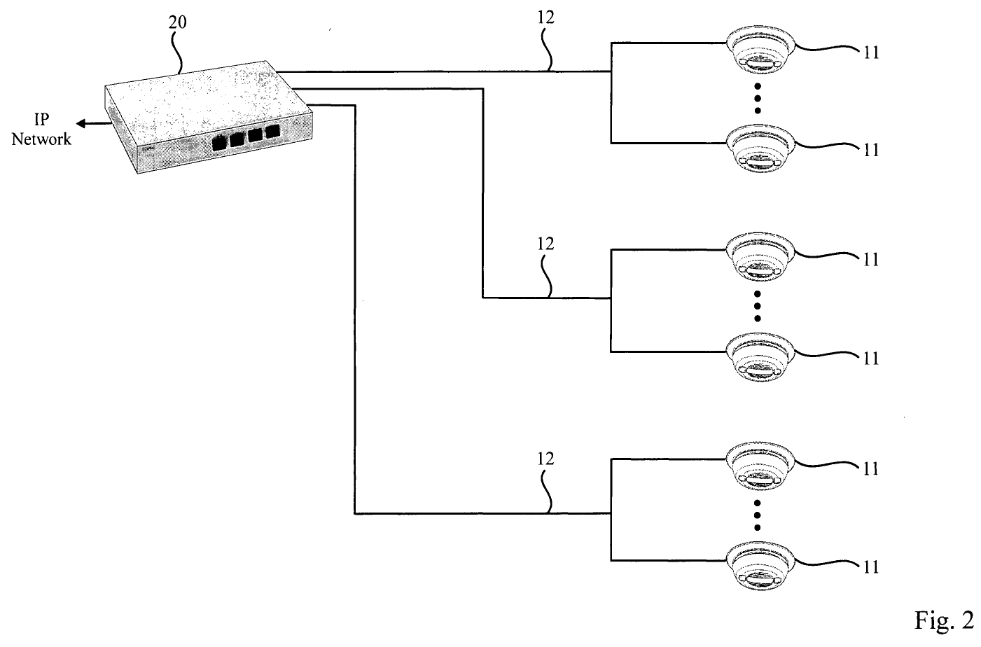

FIG. 2 illustrates the operation of the new system integrated with a fire control system. In this embodiment, the network elements are within the detectors, offering one combined unit, which can support new or existing standards. The combined element may alert using both the fire alert system and the new communication system.

In case there is a combined unit 20 which is used both for controlling the communication system and detecting fires, several signals may be sent while making an alert—for example signals at low frequencies, similar to those of traditional fire alert systems, and using additional signals at a separate bandwidth, to benefit from the advantages of the communication system.

This combination can make a more reliable alert, so there will be a fallback path to the traditional alerting signals.

In another embodiment, the supply voltage for the fire alert system will be raised, for example to 48V. This will decrease partial currents at the wires and will allow supplying power over larger distances, such as four times farther.

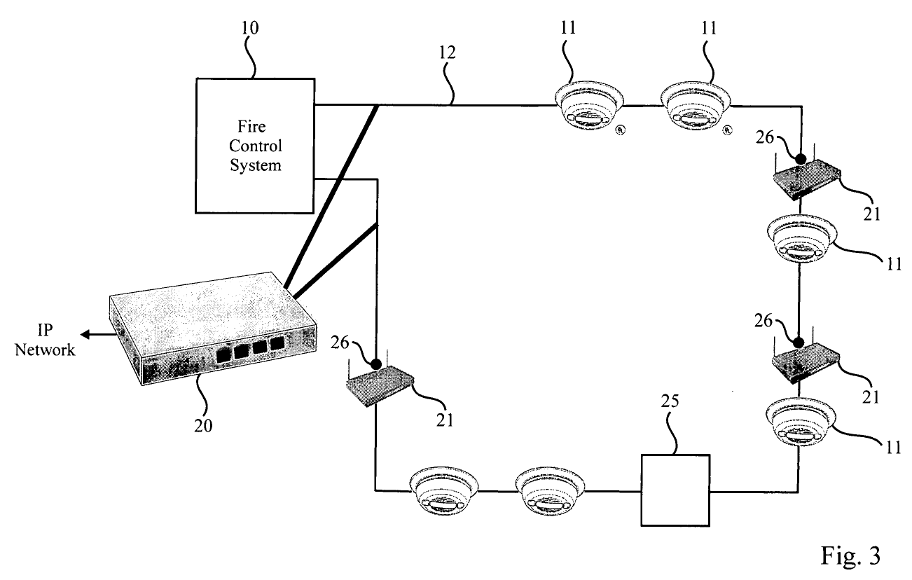

FIG. 3 illustrates the operation of the new system with a loop connection. Technical means 26 may be used to allow improved sharing of resources between the network elements. This may include network adapters, which can allow easy connection of different products to the network. This may be implemented under the supervision and commands given by the communication system controller 20.

Means 26 may allow connecting standard products, and the network could function as a standard network from the user's viewpoint. In the system as shown, no filters are used, since the fire alert system and the communication system may work in parallel on the same wires, without interfering with each other.

In one embodiment, means for sharing power supply are defined so that the fire alarm system and the communication system can share the same power supply, thus the sensors and the network elements can work under the same voltage, for example.

Additional options may include monitoring of hazards and/or operation of the detectors by the network elements as well, allowing to improve the alert performance and to supervise the operation of the detectors as well. For example, if a network adapter is sensing an alarm is issued by a detector, it can notify about it as well, or disconnect in order to prevent a further interference.

It is possible to install additional components 25 within a loop in order to better maintain the loop connection, for example allowing fire alarm signals to pass in both directions, but dividing the communication system into two different networks on the same loop, thus achieving a higher bandwidth at each branch.

Method for Using a Fire Alert System

A method for using a fire alert system and its wires to support communication services according to this invention comprises:

1. Installing a communication system with one controller, which may be separated from the fire alert system controller or may consist of a fire alert controller within, replacing the existing fire alert controller.

2. Connecting the communication controller to the existing wiring system, either directly or through filters. The fire alert system may be separated from the communication system components by filters as well.

3. Placing network adapters and/or other devices along the wires, preferably j but not necessarily close to fire detectors; alternatively, they may include the fire detectors therein. Each apparatus or network adapter may have a unique address, so that the communication controller could better control it.

4. The new combined system would be able to prompt any required alert and maintain efficient communication network, which is controlled by the communication controller. In case of alert, relevant data may be sent using the communication components as well.

5. The combined system may support existing standards for communications and/or for fire alerting, for example using Ethernet protocol for communications. New standards may be developed as well. End of method.

It will be recognized that the foregoing is but one example of a device within the scope of the present invention and that various modifications will occur to those skilled in the art upon reading the disclosure set forth hereinbefore.

What is claimed is:

1. A second communication system using existing wires of a first alert system for other, additional communications purposes, comprising means for connecting to the wires in two or more locations, and means for connecting to external communication devices in each location.

2. The communication system according to claim 1, wherein the alert system comprises a fire alarm system.

3. The communication system according to claim 1, further including a communication system controller for supporting the second communications system.

4. The communication system according to claim 1, further including means for insulating the second communication system and its devices from the first alert system and its detectors.

5. The communication system according to claim 4, wherein the insulating means comprise filters.

6. The communication system according to claim 5, wherein the filters are connected in parallel or serially to the wiring system, according to the nature of the connection of the detectors, in order to electronically separate between the two systems.

7. The communication system according to claim 4, wherein the insulating means comprise means for modulating the communication signals at frequencies where the alert system is inactive or not affected thereby.

8. The communication system according to claim 4, wherein the insulating means comprise means for blocking the line voltage of the sensors and supplying a required voltage to dedicated standard elements for replacing existing sensors.

9. The communication system according to claim 1, wherein the existing wires are connected in star and the second communication system is connected to several branches separately, allowing users of each branch to share the whole possible bandwidth, without interfering with users of other branches.

10. The communication system according to claim 1, wherein the existing wires are connected in a loop and elements of the second communication system are installed within the loop.

11. The communication system according to claim 1, wherein the second communication system further includes broadband switches, network elements and adapters for connecting the network elements to the existing wires.

12. The communication system according to claim 11, wherein the broadband switches, network elements and adapters support standard protocols.

13. The communication system according to claim 1, wherein the second communication system further includes access point elements installed close to detectors of the alert system, for connecting to external users.

14. The communication system according to claim 1, where the network elements or devices are installed within the alert system detectors, offering one combined unit, which can support requirements of both the communication system and the alert system.

15. A method for using a fire alert system and its wires to support communication services, comprising:
a. Installing a communication system with one controller, which may be separated from the fire alert system controller or may consist of a fire alert controller within, replacing the existing fire alert controller;
b. Connecting the communication controller to the existing wiring system, either directly or through filters;
c. Placing network adapters along the wires;
d. Providing the dual service of prompting of any required alert and maintaining efficient communication network.

16. The method for using a fire alert system according to claim 15, wherein further supporting existing standards for communications and/or for fire alerting.

17. The method for using a fire alert system according to claim 16, wherein the standards include the Ethernet protocol for communications.

18. The method for using a fire alert system according to claim 15, wherein separating the fire alert system from the communication system components by filters as well.

19. The method for using a fire alert system according to claim 15, wherein placing network adapters and/or other devices along the wires, close to fire detectors.

20. The method for using a fire alert system according to claim 15, wherein placing network adapters and/or other devices within the fire detectors.
